(19) United States
(12) Patent Application Publication
(10) Pub. No.: US 2025/0351050 A1
(43) Pub. Date: Nov. 13, 2025

(54) MULTIPLEXING AND DIVERSITY FOR MULTI-AIRCRAFT EMERGENCY MESSAGE RELAYING

(71) Applicant: QUALCOMM Incorporated, San Diego, CA (US)

(72) Inventors: Mingxi YIN, Beijing (CN); Kangqi LIU, San Diego, CA (US); Chao WEI, Beijing (CN); Ruiming ZHENG, Beijing (CN); Qiaoyu LI, Beijing (CN); Hao XU, Beijing (CN)

(21) Appl. No.: 18/867,404

(22) PCT Filed: Jul. 15, 2022
(86) PCT No.: PCT/CN2022/105913

§ 371 Date: Nov. 19, 2024

(51) Int. Cl. H04W 40/24; H04W 4/90; H04W 84/06; H04W 88/04

(52) U.S. Cl. CPC H04W 40/246; H04W 4/90; H04W 84/06; H04W 88/04

(57) ABSTRACT

A method of wireless communication by an aircraft-based device includes receiving a dynamic relay identification (ID). The method also includes communicating a discovery signal with resources mapped to the relay ID. The method further includes communicating a response signal with the resources mapped to the relay ID. A method for wireless communication by a network device includes estimating a position of each of a number of aircraft-based devices. The method also includes transmitting a dynamic relay identification (ID) to each of the aircraft-based devices based on the respective estimated position relative to an out-of-coverage area.

### FIELD OF THE DISCLOSURE

The present disclosure relates generally to wireless communications, and more specifically to resource multiplexing and transmit diversity for multi-aircraft emergency message relaying.

### BACKGROUND

Wireless communications systems are widely deployed to provide various telecommunications services such as telephony, video, data, messaging, and broadcasts. Typical wireless communications systems may employ multiple-access technologies capable of supporting communications with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and long term evolution (LTE). LTE/LTE-Advanced is a set of enhancements to the universal mobile telecommunications system (UMTS) mobile standard promulgated by the Third Generation Partnership Project (3GPP). Narrowband (NB)-Internet of things (IoT) and enhanced machine-type communications (eMTC) are a set of enhancements to LTE for machine type communications.

A wireless communications network may include a number of base stations (BSs) that can support communications for a number of user equipment (UEs). A user equipment (UE) may communicate with a base station (BS) via the downlink and uplink. The downlink (or forward link) refers to the communications link from the BS to the UE, and the uplink (or reverse link) refers to the communications link from the UE to the BS. As will be described in more detail, a BS may be referred to as a Node B, an evolved Node B (eNB), a gNB, an access point (AP), a radio head, a transmit and receive point (TRP), a new radio (NR) BS, a 5G Node B, and/or the like.

The above multiple access technologies have been adopted in various telecommunications standards to provide a common protocol that enables different user equipment to communicate on a municipal, national, regional, and even global level. New radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation.

### SUMMARY

In aspects of the present disclosure, a method of wireless communication by an aircraft-based device includes receiving a dynamic relay identification (ID). The method also includes communicating a discovery signal with resources mapped to the relay ID. The method further includes communicating a response signal with the resources mapped to the relay ID.

In other aspects of the present disclosure, a method for wireless communication by a network device includes estimating a position of each of a number of aircraft-based devices. The method also includes transmitting a dynamic relay identification (ID) to each of the number of aircraft-based devices based on the respective estimated position relative to an out-of-coverage area.

Other aspects of the present disclosure are directed to an apparatus. The apparatus has a memory and one or more processor(s) coupled to the memory. The processor(s) is configured to receive a dynamic relay identification (ID). The processor(s) is also configured to communicate a discovery signal with resources mapped to the relay ID. The processor(s) is further configured to communicate a response signal with the resources mapped to the relay ID.

Still other aspects of the present disclosure are directed to an apparatus. The apparatus has a memory and one or more processor(s) coupled to the memory. The processor(s) is configured to estimate a position of each of a number of aircraft-based devices. The processor(s) is also configured to transmit a dynamic relay identification (ID) to each of the number of aircraft-based devices based on the respective estimated position relative to an out-of-coverage area.

Aspects generally include a method, apparatus, system, computer program product, non-transitory computer-readable medium, user equipment, base station, wireless communications device, and processing system as substantially described with reference to and as illustrated by the accompanying drawings and specification.

The foregoing has outlined rather broadly the features and technical advantages of examples according to the disclosure in order that the detailed description that follows may be better understood. Additional features and advantages will be described. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that features of the present disclosure can be understood in detail, a particular description may be had by reference to aspects, some of which are illustrated in the appended drawings. It is to be noted, however, that the appended drawings illustrate only certain aspects of this disclosure and are therefore not to be considered limiting of its scope, for the description may admit to other equally effective aspects. The same reference numbers in different drawings may identify the same or similar elements.

FIG. 1 illustrates an example wireless communications system that supports emergency messaging using mobile relay, in accordance with aspects of the present disclosure.

FIG. 2 illustrates an example wireless communications system that supports emergency messaging using mobile relay, in accordance with aspects of the present disclosure.

FIG. 3 illustrates an example wireless communications system that supports emergency messaging using mobile relay, in accordance with aspects of the present disclosure.

FIG. 4 is a diagram illustrating multiple aircraft covering a same out-of-cellular coverage area, in accordance with aspects of the present disclosure.

FIG. 5 is a diagram illustrating communications based on relay identifications (IDs), in accordance with aspects of the present disclosure.

FIG. 6 is a diagram illustrating aircraft synchronization, in accordance with aspects of the present disclosure.

FIG. 7 is a block diagram illustrating time domain guard gaps, in accordance with aspects of the present disclosure.

FIG. 8 is a block diagram illustrating frequency domain guard gaps, in accordance with aspects of the present disclosure.

FIG. 9 is a flow diagram illustrating an example process performed, for example, by an aircraft-based device, in accordance with various aspects of the present disclosure.

FIG. 10 is a flow diagram illustrating an example process performed, for example, by a network device, in accordance with various aspects of the present disclosure.

### DETAILED DESCRIPTION

Various aspects of the disclosure are described more fully below with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings, one skilled in the art should appreciate that the scope of the disclosure is intended to cover any aspect of the disclosure, whether implemented independently of or combined with any other aspect of the disclosure. For example, an apparatus may be implemented or a method may be practiced using any number of the aspects set forth. In addition, the scope of the disclosure is intended to cover such an apparatus or method, which is practiced using other structure, functionality, or structure and functionality in addition to or other than the various aspects of the disclosure set forth. It should be understood that any aspect of the disclosure disclosed may be embodied by one or more elements of a claim.

Several aspects of telecommunications systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described using terminology commonly associated with 5G and later wireless technologies, aspects of the present disclosure can be applied in other generation-based communications systems, such as and including 3G and/or 4G technologies.

Aspects of the present disclosure relate to improved methods, systems, devices, and apparatuses that support emergency messaging using a mobile relay. Generally, the described techniques provide for a first user equipment (UE) that is outside the coverage area of a network entity (e.g., does not have cellular coverage), to transmit emergency messages to a second UE (e.g., aircraft UE) for relaying to a network entity. For example, the first UE may broadcast, according to a beam sweeping procedure, a first emergency message indicating a request for relaying a second emergency message to one or more network entities. The second UE, which may be associated with an aircraft, may receive the first emergency message and transmit a feedback message in response to the first emergency message. In some cases, the feedback message may include an indication that the second UE is in communication with or capable of communicating with a network entity over an air-to-ground (ATG) wireless communications network or a satellite entity, an indication of a set of resources for transmitting the second emergency message, or both. The first UE may receive the feedback message and may unicast the second emergency message to the second UE (e.g., via the indicated set of resources) based on receiving the feedback message. The second UE may receive the second emergency message and transmit an indication of the first emergency message, the second emergency message, or both, to a network entity.

Throughout the disclosure, the aircraft (e.g., second UE in the paragraphs above) are referred to as UEs for ease of explanation. It is noted, however, that an aircraft may be a UE, a base station, an IAB device, a relay, a smart repeater, or any other such device.

In some cases, the second UE may transmit the indication directly to the network entity while, in some other cases, the second UE may transmit the indication to a third UE, and the third UE may transmit the indication to the network entity. Additionally, the second UE may transmit a second feedback message to the first UE based on receiving the second emergency message and the first UE may refrain from transmitting additional emergency messages based on the second feedback message.

Aspects of the disclosure are initially described in the context of wireless communications systems. Aspects of the disclosure are then described in the context of a cooperative emergency messaging process and a process flow. Aspects of the disclosure are further illustrated by and described with reference to apparatus diagrams, system diagrams, and flowcharts that relate to emergency messaging using mobile relay.

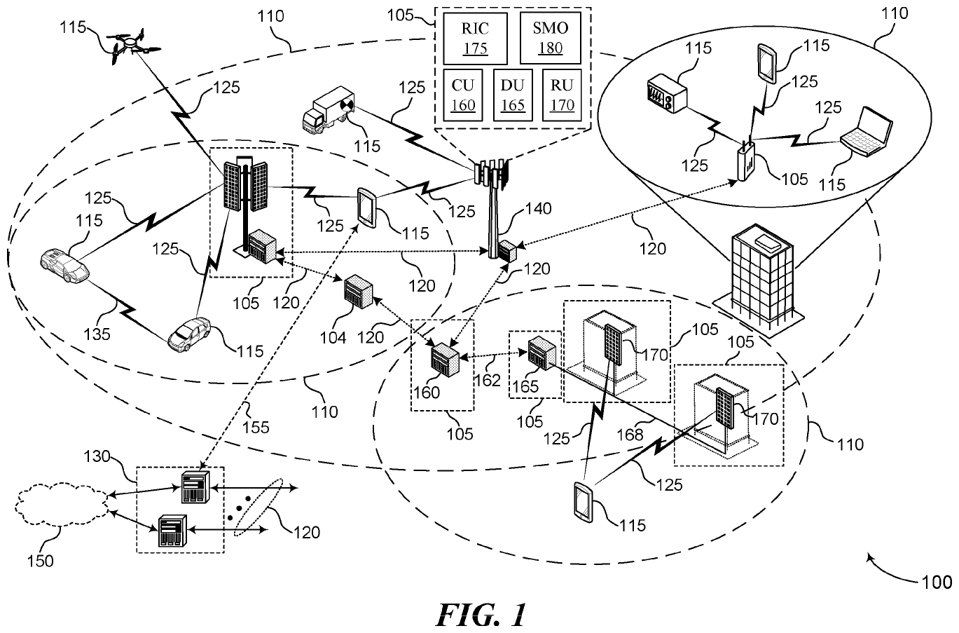

FIG. 1 illustrates an example of a wireless communications system 100 that supports emergency messaging using mobile relay in accordance with one or more aspects of the present disclosure. The wireless communications system 100 may include one or more network entities 105, one or more UEs 115, and a core network 130. In some examples, the wireless communications system 100 may be a long term evolution (LTE) network, an LTE-advanced (LTE-A) network, an LTE-A Pro network, a new radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described may be able to communicate with various types of devices, such as other UEs 115 or network entities 105, as shown in FIG. 1.

As described, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN intelligent controller (RIC) 175 (e.g., a near-real time RIC (near-RT RIC), a non-real time RIC (Non-RT RIC)), a service management and orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), and/or a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., radio resource control (RRC), service data adaption protocol (SDAP), packet data convergence protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an JAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual JAB-MT (vIAB-MT)). In some examples, the JAB nodes 104 may include DUs 165 that support communication links with additional entities (e.g., IAB nodes 104 and UEs 115) within the relay chain or configuration of the access network (e.g., downstream). In such cases, one or more components of the disaggregated RAN architecture (e.g., one or more IAB nodes 104 or components of TAB nodes 104) may be configured to operate according to the techniques described herein.

In the case of the techniques described applied in the context of a disaggregated RAN architecture, one or more components of the disaggregated RAN architecture may be configured to support emergency messaging using mobile relay as described. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, and SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, and NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of a one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δƒₘₐₓ·N_{ƒ}) seconds, where Δƒₘₐₓ may represent the maximum supported subcarrier spacing, and Nf may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{ƒ}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a packet data network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP multimedia subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz

The wireless communications system 100 may utilize both licensed and unlicensed RF spectrum bands. For example, the wireless communications system 100 may employ license assisted access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations, or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., abase station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

Some wireless communications systems may support emergency (e.g., SOS) messaging from a user equipment (UE), such as a terrestrial UE. For example, the terrestrial UE may support emergency messaging with an aircraft UE communicating over an air-to-ground (ATG) wireless communication node when the terrestrial UE is out of the cellular coverage area of a network entity (e.g., the terrestrial UE does not have cellular coverage). That is, the terrestrial UE may transmit an emergency message to the aircraft UE, and the aircraft UE may relay the emergency message to a network entity. In some cases, to initiate communications with the terrestrial UE, the aircraft UE may transmit discovery signaling. However, transmitting the discovery signaling may result in interference with terrestrial communications. In some other cases, the terrestrial UE may transmit repetitions of the emergency message for the aircraft UE to receive. In such cases, signaling repetitions of an emergency message by the terrestrial UE may result in increased power consumption at the terrestrial UE. Throughout the disclosure, the aircraft are referred to as UEs for ease of explanation. It is noted, however, that an aircraft may be a UE, a base station, an IAB device, a relay, a smart repeater, or any other such device.

Two-part emergency messaging may be employed with a mobile relay. For example, a first UE may broadcast a first emergency message indicating a request for relaying a second emergency message to a network entity. A second UE (e.g., a relay node) may receive the first emergency message and transmit a feedback message in response to the first emergency message indicating that the second UE is available to relay the second emergency message. In some cases, the feedback message may include an indication that the second UE may relay the second emergency message over an ATG wireless communications network. Additionally, or alternatively, the feedback message may include an indication of resources for transmitting the second emergency message. The first UE may receive the feedback message and unicast the second emergency message to the second UE (e.g., via the indicated resources). The second UE may receive the second emergency message and relay an indication of an emergency message (e.g., the first emergency message, the second emergency message, or both) to a network entity, either directly or via additional UEs (e.g., relay nodes).

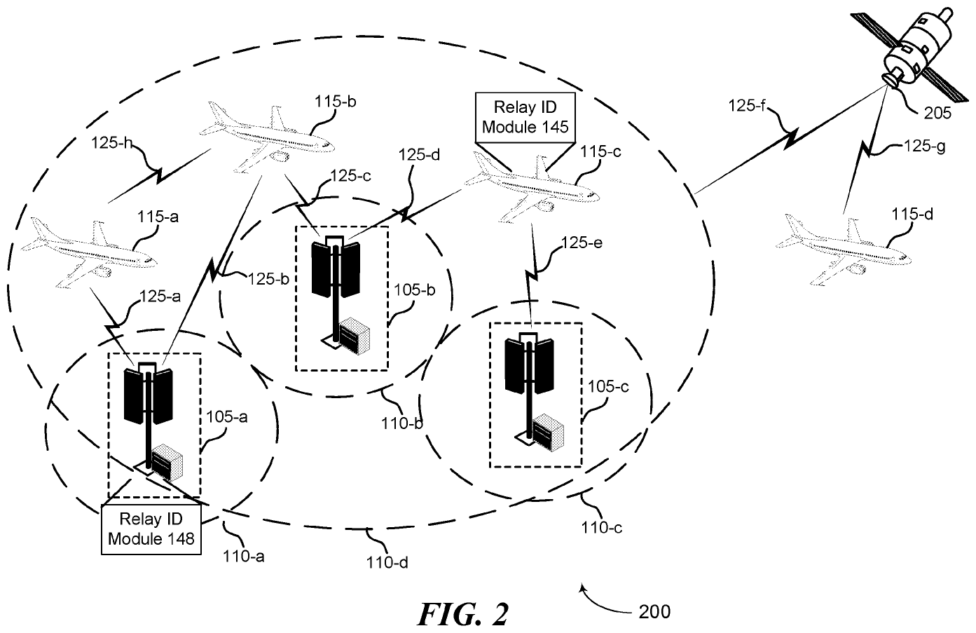

FIG. 2 illustrates an example of a wireless communications system 200 that supports emergency messaging using mobile relay in accordance with one or more aspects of the present disclosure. The wireless communications system 200 may implement or be implemented by aspects of the wireless communications system 100 as described with reference to FIG. 1. For example, the wireless communications system 200 may include a network entity 105-a, a network entity 105-b, and a network entity 105-c which may represent examples of network entities 105 as described, including with reference to FIG. 1. Additionally, the wireless communications system 200 may include a UE 115-a, a UE 115-b, a UE 115-c, and a UE 115-d which may represent examples of UEs 115 as described, including with reference to FIG. 1.

The network entities 105 may each correspond to a coverage area 110, such as a coverage area 110-a, a coverage area 110-b, and a coverage area 110-c, which may be examples of coverage areas 110 as described with reference to FIG. 1. For example, the network entity 105-a may serve a coverage area 110-a, the network entity 105-b may serve a coverage area 110-b, and the network entity 105-c may serve a coverage area 110-c. The network entities 105 may communicate with UEs 115 via one or more communication links 125, such as a communication link 125-a, a communication link 125-b, a communication link 125-c, a communication link 125-d, a communication link 125-e, a communication link 125-f, and a communication link 125-g, which may represent examples of communication links 125 as described with reference to FIG. 1. In some examples, the UEs 115 may be examples of airplanes or other wireless devices (e.g., drones, vehicles, or other examples of wireless communications devices).

The wireless communications system 200 may support various types of communications, such as ATG communications. For example, in an inland or coastal area, the network entity 105-a (e.g., a gNB, such as an ATG-gNB) may be on the ground and transmit communications via an antenna that is tilted up towards the UE 115-a. The UE 115-a may be an example of an ATG-UE and may receive the communications with an antenna pointing down (e.g., the UE 115-a may include antennas at the bottom of the UE 115-a). For example, an antenna of the aircraft UE 115-a may be mounted at a bottom of the aircraft (e.g., antennas with beamforming capabilities). Such wireless communications may be relatively low cost, relatively high throughput, realize lower latency, or any combination thereof, compared to satellite communications with a satellite 205. In some examples, the wireless communications system 200 may support one or more traffic types (e.g., aircraft passenger communications, air traffic management communications, aircraft surveillance or maintenance communications, air traffic control, and the like). In some cases, the one or more traffic types may be present based on the location of the UEs 115 (e.g., in-flight passenger communications present en-route during commercial flights and/or in-flight passenger communications present during takeoff (e.g., climb) and landing (e.g., descent) during business aviation).

Additionally, or alternatively, the wireless communications system 200 may support communications with the satellite 205. For example, the satellite 205 may communicate with the UE 115-d (e.g., in an ocean area where the UE 115-d may be outside the coverage area 110-c associated with the network entity 105-c). The satellite 205 may communicate with devices in the coverage area 110-d. For example, the network entity 105-c may transmit or receive communications with the satellite 205, and the satellite 205 may transmit or receive communications with the UE 115-d via the communication link 125-g.

In some examples, the wireless communications system 200 may support TDD or FDD communications, including FDD communications in a non-terrestrial network (NTN). In some examples, the wireless communications system 200 may support relatively large inter-site distances (ISD), relatively large coverage ranges, or a combination thereof. For example, in order to control the network deployment cost and account for a quantity of flights, a large ISD may be implemented (e.g., 100 kilometers (km), 200 km, or another range). Additionally, or alternatively, the distance between a UE 115 and a network entity 105 may be relatively large (e.g., when a plane is above the sea, the distance may be more than 200 km), and thus the wireless communications system 200 (e.g., an ATG network) may be configured to provide a relatively large cell coverage (e.g., up to 300 km cell coverage).

In some examples, the wireless communications system 200 may support both ATG communications (e.g., an ATG network) and a terrestrial NR network. For example, interference between the terrestrial network and the ATG network may be relatively low and some operators may adopt a same frequency for deploying both networks (e.g., 4.8 GHz). In some examples, an ATG terminal (e.g., a UE 115) may have a relatively large capacity. For example, an on-board ATG terminal may be relatively more powerful than a mobile device UE 115 (e.g., the terminal may have a higher effective isotropically radiated power (EIRP), larger transmission power, or larger on-board antenna gain than some terrestrial UEs 115).

In some examples, the wireless communications system 200 may support one or more throughput attributes and specifications for NR-ATG communications. In some examples, the wireless communications system 200 may support a data rate per personal device (e.g., 15 megabits-per-second (Mbps) in the downlink and 7.5 Mbps in the uplink), which may also apply to cell-edge devices. In some examples, the wireless communications system 200 may support an end-to-end latency (e.g., 10 milliseconds (ms)). In some examples, the wireless communications system 200 may support a degree of mobility (e.g., up to 1200 km per hour (km/h)) for UEs 115. In some examples, the wireless communications system 200 may support a connection density (e.g., 80 personal devices per aircraft, 60 aircraft per 18,000 square km, or another connection density). In some cases, to enable the connection density, the wireless communications system 200 may support a quantity of sectors per cell (e.g., 3 sectors per cell) where each cell may include a quantity of supported devices (e.g., 20 aircraft). In some examples, the wireless communications system 200 may support a data rate per aircraft (e.g., 1.2 gigabits-per-second (Gbps) in the downlink, and 600 Mbps in the uplink), which may also apply to cell-edge devices. In one example, such aircraft may include 400 passengers, and at a 20% activation factor, and there may be 80 personal devices per aircraft.

In some cases, the wireless communications system 200 may be configured as described to support relatively large cell coverage ranges (e.g., up to 300 km), flight speeds (e.g., 1200 km/hour flight speeds), coexistence between ATG networks and terrestrial networks, ATG base station or UE core and performance thresholds, or any combination thereof. For example, the wireless communications system 200 may support a relatively large ISD (e.g., 100 km to 200 km in-land, and up to 300 km coverage along coasts). Additionally, or alternatively, the wireless communications system 200 may support a relatively large timing advance (TA) (e.g., a TA value equal to 2 ms at 300 km of coverage) to avoid frequent handover and inter-cell interference.

Additionally, or alternatively, wireless communications system 200 may support a relatively large per-cell throughput (e.g., a data rate of at least 1 Gbps per aircraft). For example, an aircraft may experience a 1.2 Gbps data rate for downlink communications, and a 600 Mbps data rate for uplink communications. Such large per-cell throughput may occur in airspaces that have a density of 60 aircraft per 18,000 square km, for cell coverage ranges of 134 km. In cases where aircraft or airspace densities are high (e.g., congested, such as around busy airports), data rates may decrease, but may still remain at or above the 1 Gbps data rate per aircraft specification.

Additionally, or alternatively, wireless communications system 200 may support a relatively large Doppler shift in frequency (e.g., a line of sight (LoS) maximum Doppler shift at 1200 km/h may be about 0.77 kHz at 700 MHz, or 3.89 kHz at 3.5 GHz, or 5.33 kHz at 4.8 GHz), a relatively large subcarrier spacing (SCS) (e.g., an SCS value of 7.5 kHz at 700 MHz, or 30 kHz or 60 kHz at 3.5 GHz, or 60 kHz at 4.8 GHz, assuming a receiver on a device may tolerate a maximum LoS Doppler shift of about 10 percent of the SCS), a relatively short coherence time, a relatively fast TA drift, or any combination of these.

Additionally, or alternatively, wireless communications system 200 may support various CP lengths or waveforms. These may support various propagation scenarios such as en-route, climbing, descending, take-off, landing, taxiing, or parking of an aircraft, and the like. In en-route, climbing, and descent propagation scenarios, signals may fade according to a Rician model due to interactions between propagation paths of signals. For example, there may be a signal delay of up to 2.5 km for en-route scenarios, corresponding to an 8.33 microseconds (μs) delay in time. In take-off, landing, taxiing, and parking propagation scenarios, signals may fade according to a Rayleigh model due to interactions between propagation paths of signals. In climbing and descent, or take-off and landing propagation scenarios, or both, a signal delay may be comparable to or less than that of en-route (e.g., still relatively large). Parking and taxi delays may be similar to terrestrial-like delays.

Additionally, or alternatively, wireless communications system 200 may cause interference towards terrestrial NR systems if frequencies are reused. For example, aircraft transmission beam widths may become larger (e.g., after 100 km to 200 km of propagation), affecting a relatively wide terrestrial area. Such interference may be relatively dynamic and non-synchronized when accounting for effects of dynamic time division duplexing (TDD) and large propagation delays.

The wireless communications system 200 may communicate according to a UAC protocol. In an NR system, a UAC protocol may allow operator devices (e.g., network entities 105, or the like) to control access of subscriber devices (e.g., UEs 115, or the like) to a particular NR system or network. Depending on operator policies, deployment scenarios, subscriber profiles, available services, or any combination of these, operator devices may use different criteria in determining which access attempts by subscriber devices may be allowed or blocked (e.g., when congestion occurs in the NR system or network). These different criteria (e.g., characteristics, time, location, proximity, interference, or any other criteria) may be associated with various access identities, access categories, or both. Thus, operator devices may categorize each access attempt into one or more access identities, access categories, or both. In some cases, an access identity may be associated with a UE 115 subscription type, and an access category may be associated with a UE 115 service (e.g., emergency, voice call, or the like) that may be triggering the access attempt.

The wireless communications system 200 may support a two-part emergency message using mobile relay as described. For example, a first UE, such as a terrestrial UE 115, may lose cellular coverage and may broadcast a first emergency message indicating a request to relay a second emergency message to a network entity 105. A second UE 115, such as a UE 115-a (e.g., an aircraft UE 115), may receive the first emergency message and may transmit a first feedback message to the terrestrial UE 115 based on receiving the first emergency message. In some cases, the first feedback message may include an indication that the UE 115-a is available for relaying messages, the UE 115-a is capable of communicating over an ATG wireless communications network, an indication of resources for the second emergency message, or any combination thereof. The terrestrial UE 115 may receive the first feedback message and may unicast the second emergency message to the UE 115-a. The UE 115-a may receive the second emergency message and transmit an indication of an emergency message (e.g., the first emergency message, the second emergency message, or both) to a network entity 105, such as a network entity 105-a. In some cases, the UE 115-a may transmit the indication of the emergency message directly to the network entity 105-a via the communication link 125-a. In some other cases, the UE 115-a may transmit the indication of the emergency message to another UE 115, such as the UE 115-b, for additional relaying. For example, the UE 115-a may transmit the indication of the emergency message to the UE 115-b via a communication link 125-h and the UE 115-b may transmit the indication of the emergency message to the network entity 105-b via the communication link 125-b or to the network entity 105-c via the communication link 125-c.

The UEs 115 may include a relay identification (ID) module 145. For brevity, only one UE 115-c is shown as including the relay ID module 145. The relay ID module 145 may receive a dynamic relay identification (ID). The relay ID module 145 may also communicate a discovery signal with resources mapped to the relay ID. The relay ID module 145 may further communicate a response signal with the resources mapped to the relay ID.

The core network 130 or the network entities 105 or any other network device may include a relay ID module 148. For brevity, only one 105-a is shown as including the relay ID module 148. The relay ID module 148 may estimate a position of each of a group of aircraft-based devices. The relay ID module 148 may also transmit a dynamic relay identification (ID) to each of the aircraft-based devices based on the respective estimated position relative to an out-of-coverage area.

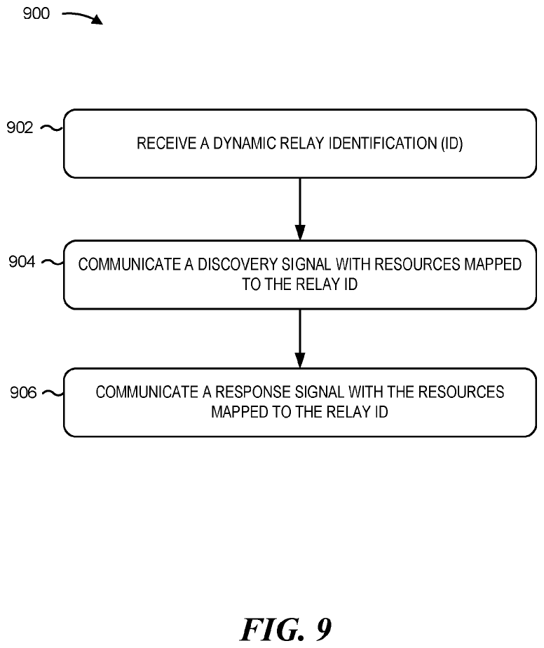

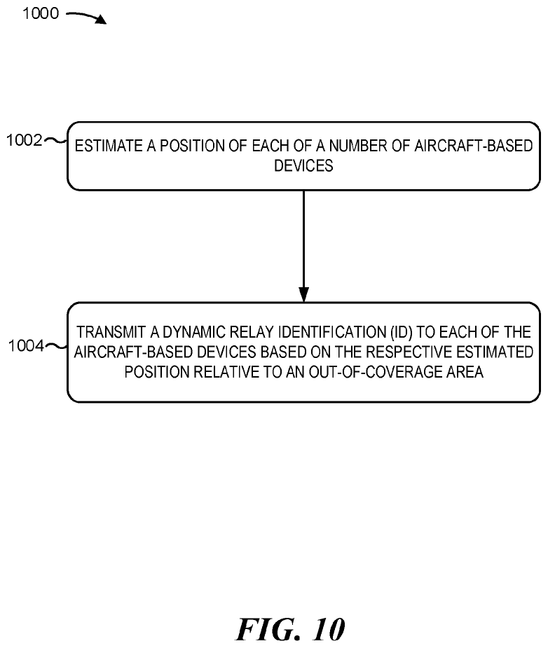

A controller/processor of the network entity 105, a controller/processor of the UE 115, and/or any other component(s) may perform one or more techniques associated with dynamic relay IDs, as described in more detail elsewhere. For example, the controller/processor of the network entity 105, the controller/processor of the UE 115, and/or any other component(s) may perform or direct operations of, for example, the processes of FIGS. 9 and 10 and/or other processes as described.

In some aspects, the UE 115 and/or network entity 105 may include means for receiving, means for communicating, means for synchronizing, means for relaying, means for calculating, means for transmitting and means for estimating. Such means may include one or more components of the UE 115 or network entity 105.

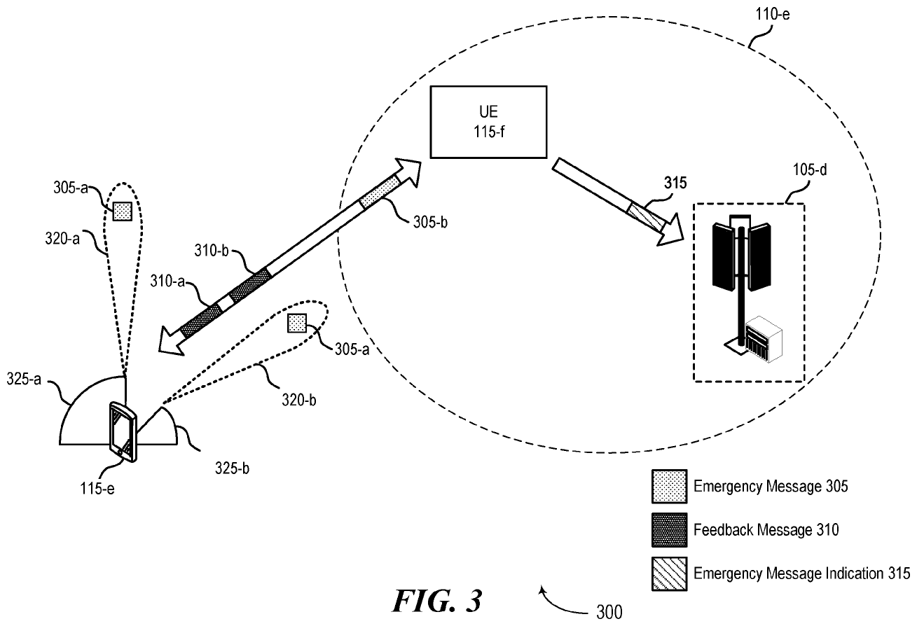

FIG. 3 illustrates an example of a wireless communications system 300 that supports emergency messaging using mobile relay in accordance with one or more aspects of the present disclosure. The wireless communications system 300 may implement or be implemented by aspects of the wireless communications system 100 and the wireless communications system 200. For example, the wireless communications system 300 may include a network entity 105-d, a UE 115-e, and a UE 115-f. The UE 115-e and the UE 115-f may represent examples of UEs 115 as described, including with reference to FIG. 1. The network entity 105-d may represent an example of a network entity 105 as described, including with reference to FIG. 1. For example, the UE 115-e may transmit emergency messages (e.g., SOS messages) according to the techniques described to support interference reduction, power saving, and service enhancements of emergency messaging transmission for the UE 115-e.

Some wireless communications systems may support emergency (e.g., SOS) messaging from a UE 115, such as a terrestrial UE 115. For example, when the terrestrial UE 115 is out of cellular coverage of a network entity 105, the UE 115 may support one or more methods for delivering (e.g., transmitting) emergency messages. In some cases, the terrestrial UE 115 may transmit an emergency message to a satellite entity (e.g., iridium-like message delivery). However, the terrestrial UE 115 may transmit the emergency message based on strict antenna and transmit power parameters (e.g., requirements). As such, the terrestrial UE 115 may successfully transmit the emergency message by pointing one or more antennas at the terrestrial UE 115 towards the satellite entity while transmitting the emergency message to avoid blockage (e.g., which may require skillful human-assisted operations). Additionally, the terrestrial UE 115 may be unable to transmit machine type communications (MTC) based on a form factor of the terrestrial UE 115.

In some cases, the terrestrial UE 115 may transmit an emergency message to a satellite entity using an air interface associated with the satellite entity. However, not all satellite entities may be associated with this air interface and, as such, the terrestrial UE 115 may attempt to transmit an emergency message over the air interface but may be unsuccessful due to lack of coverage from the satellite entity associated with the air interface. Moreover, launching satellites associated with air interfaces may be associated with high deployment costs. In other examples, the terrestrial UE may not be capable of transmitting signals at a sufficient power to reach a satellite, which can be a longer distance away from the terrestrial UE.

In some cases, the terrestrial UE 115 may transmit an emergency message to an aircraft UE 115 (e.g., to extend coverage for areas without terrestrial network entities 105). Aircraft UEs 115 may cruise at an altitude (e.g., 10 km) that may support LoS propagation for over 200 km (e.g., and there may be at least one aircraft visible within 50-100 km in most major remote areas). Additionally, transmitting an emergency message to an aircraft UE 115 may reduce deployment costs and support decreased human-assistance in operating the terrestrial UE 115 compared to emergency messaging via satellite entities. In some cases, to support emergency messaging, the aircraft UE 115 may constantly broadcast a discovery announcement signal covering a wide area which may cause severe interference towards terrestrial communications (e.g., due to terrestrial communications sharing the same frequency as ATG communications). Additionally, the aircraft UE 115 may be unaware of the existence of the terrestrial UE 115 (e.g., out-of-coverage remote device). In some other cases, the terrestrial UE 115 may transmit repetitions of the emergency message, which may result in increased power consumption.

Techniques may support two-part emergency messaging using mobile relay. In some cases, a UE 115-e (e.g., a terrestrial UE 115) may leave (e.g., go out of range of) a cellular coverage area of a network entity 105 (e.g., a last terrestrial-based network entity 105) and may lose cellular coverage (e.g., become an out-of-cellular-coverage UE 115). In such cases, the UE 115-e may be configured to broadcast (e.g., transmit) a first emergency message (e.g., a first part of a two part emergency message), such as an emergency message 305-a, indicating a request for relaying emergency messages (e.g., when the UE 115-e is out-of-cellular-coverage). As such, the UE 115-e may broadcast (e.g., in a PC5 interface) the emergency message 305-a via a set of broadcast resources. In some cases, the set of broadcast resources may be configured by the last network entity 105 to be in communication with the UE 115-e prior to losing coverage, by a satellite entity (e.g., satellite communication system), or by a set of parameters at the UE 115-e (e.g., preconfigured at the UE 115-e). Additionally, the emergency message 305-a may include an indication of identification for the UE 115-e (e.g., in a dedicated sequence or preamble for emergency messaging). In some cases, the UE 115-e may monitor for a feedback message 310 from a UE 115, such as a UE 115-f, during a period of time (e.g., a configured window) following transmission of the emergency message 305-a.

In some cases, the UE 115-e may broadcast the emergency message 305-a via one or more beams 320, such as a beam 320-a and a beam 320-b, according to a beam sweeping procedure (e.g., scheme). In some examples, the beam sweeping procedure may be a non-uniform beam sweeping procedure. This may be because UEs associated with aircraft may be positioned at different angles from the terrestrial UE than terrestrial-based network entities or other UEs. That is, the UE 115-e may be configured by a last network entity 105 (e.g., via RAN-based signaling or application layer protocols) to transmit the emergency message 305-a according to the non-uniform beam sweeping procedure, where the last network entity 105 is a network entity 105 that the UE 115-e was last (e.g., most recently) communicating with prior to becoming an out-of-cellular-coverage UE 115 (e.g., losing coverage from the last network entity 105).

The non-uniform beam sweeping procedure may include sweeping a beam with low elevation angles (e.g., less than or equal to 18 degrees), such as the beam 320-b with elevation angle 325-b, with high probability and sweeping a beam with high elevation angle (e.g., above 18 degrees), such as the beam 320-a with elevation angle 325-a, with low probability. That is, the UE 115-e may sweep the beam 320-b with elevation angle 325-b with increased repetition compared to the beam 320-a with the elevation angle 325-a. Additionally, a transmit power of beams with low elevation angles may be higher than a transmit power of beams with high elevation angles (e.g., due to aircrafts, such as the aircraft associated with the UE 115-f, typically flying between 6 and 18 degree of elevation angle with 100 km cell radius and an aircraft altitude at 10 km).

In some cases, the UE 115-e may broadcast the emergency message 305-a according to aircraft information (e.g., associated with the UE 115-f). Aircraft information may include information that may enable the UE 115-e to identify one or more UEs 115 (e.g., associated with the aircraft information, such as the UE 115-f), communicate with the one or more UEs 115, determine a location of the one or more UEs 115, determine a direction of the one or more UEs 115, determine a speed of the one or more UEs 115, or the like. For example, the aircraft information may include identification information, location information, flight path information, or any combination thereof.

In some examples, the UE 115-e may be configured to transmit the emergency message 305-a according to the aircraft information based on an indication of the aircraft information included in a control message from the last network entity 105 to be in communication with the UE 115-e prior to losing cellular coverage (e.g., via RAN-based signaling or application layer protocol) or from a satellite entity. In another example, the UE 115-e may be configured to transmit the emergency message 305-a according to the aircraft information based on one or more parameters at the UE 115-e (e.g., the aircraft information may be preconfigured at the UE 115-e). As such, the UE 115-e may monitor for a UE 115 associated with the aircraft information, such as the UE 115-f, and may transmit the emergency message 305-a based on the monitoring. That is, the UE 115-e may broadcast the emergency message 305-a when the UE 115-f is in proximity (e.g., within a distance threshold) of the UE 115-e based on the aircraft information (e.g., the UE 115-f is flying nearby the UE 115-e). Conversely, the UE 115-e may refrain from broadcasting the emergency message 305-a when the UE 115-f is not in proximity of the UE 115-e based on the aircraft information (e.g., the UE 115-g may sleep when the UE 115-f is not in proximity).

In some cases, the UE 115-e may determine that the aircraft information is valid based on one or more positions of the UE 115-e. In other words, the UE 115-e may determine an initial position (e.g., initial global navigation satellite system (GNSS) position) of the UE 115-e (e.g., a position at which the UE 115-e lost coverage) and a current position (e.g., current GNSS position) of the UE 115-e. The initial position of the UE 115-e may be the position of the UE 115-e when the UE 115-e receives the aircraft information (e.g., from the last network entity or from a satellite entity), the position of the UE 115-e when the UE 115-e loses terrestrial cellular coverage, or the like thereof. Further, the UE 115-e may compare the initial position to the current position to determine a change in position (e.g., a distance moved) and compare the change in position to a distance threshold. In some cases, the UE 115-e may determine the aircraft information is valid based on the change in position being less than or equal to (e.g., failing to exceed) the distance threshold. As such, the UE 115-g may transmit the emergency message 305-a according the aircraft information based on the aircraft information being valid. Conversely, the UE 115-e may determine the aircraft information is not valid (e.g., is invalid) based on the change in position being greater than (e.g., exceeding) the distance threshold. As such, the UE 115-g may refrain from transmitting the emergency message 305-a according to the aircraft information based on the aircraft information being invalid.

Additionally, or alternatively, the UE 115-e may transmit the emergency message 305-a according to a periodic timer (e.g., when the aircraft information is invalid). For example, the UE 115-e may be configured to transmit the emergency message 305-a according to the periodic timer based on an indication of the periodic timer included in a control message from the last network entity 105 to be in communication with the UE 115-e prior to losing cellular coverage (e.g., via RAN-based signaling or application layer protocol). In some cases, the periodic timer may indicate that the UE-115-g (associated with the aircraft) is listening to particular communication resources for some types of messages, including emergency messages. In some cases, the UE 115-e may broadcast the emergency message 305-a during an “ON” duration and refrain from broadcasting the emergency message 305-b during an “OFF” duration (e.g., the UE 115-g may sleep during the “OFF” duration). The “ON” duration and the “OFF” duration may be based on a periodic “ON” and “OFF” timer for the emergency message 305-a (e.g., indicated in the control message).

The UE 115-f (e.g., relay node) may receive the emergency message 305-a from the UE 115-e. In some cases, the UE 115-f may identify a dedicated emergency message from a specific emergency indication in the emergency message 305-a. Additionally, the UE 115-f may transmit a feedback message 310-a to the UE 115-e based on receiving the emergency message 305-a. In some embodiments, the UE 115-e may refrain from transmitting additional emergency messages 305-a based on receiving the feedback message 310-a (e.g., to reduce power consumption). In some cases, the UE 115-f may be associated with an aircraft (e.g., an aircraft UE 115). In some other cases, the UE 115-f may be a UE 115 (e.g., terrestrial UE 115) that is connected to a network entity, such as the network entity 105-d (e.g., is an in-cellular-coverage UE 115).

In some cases, the UE 115-e may be configured to transmit (e.g., a unicast transmission) a second emergency message (e.g., a second part of a two part emergency message), such as an emergency message 305-b, including emergency information based on receiving the feedback message 310-a. As such, the UE 115-e may transmit (e.g., in a PC5 interface) the emergency message 305-b via a set of unicast resources (e.g., sidelink resources). In some cases, the set of unicast resources may be configured by the last network entity 105 to be in communication with the UE 115-e prior to losing coverage, by a satellite entity (e.g., satellite communication system), by a set of parameters at the UE 115-e, or based on the feedback message 310-a (e.g., an indication in the feedback message 310-a). Additionally, the emergency message 305-b may include an indication of identification for the UE 115-e.

In some cases, the UE 115-f may transmit a feedback message 310-b based on receiving the emergency message 305-b. Additionally, the UE 115-f may transmit (e.g., relay) an emergency message indication 315 to the network entity 105-d, the emergency message indication 315 being based on the emergency message 305-a, the emergency message 305-b, or both. That is, the UE 115-f may relay the emergency message 305-a, the emergency message 305-b, or both, to the network entity 105-d. In some cases, the UE 115-f may transmit the emergency message indication 315 to a satellite entity or another UE 115 (e.g., which may relay the emergency message indication 315 to the network entity 105-d). In some embodiments, the UE 115-e may refrain from broadcasting the emergency message 305-a, unicasting the emergency message 305-b, or both, based on receiving the feedback message 310-b (e.g., from at least one UE 115, such as the UE 115-f).

Though described in the context of a UE 115-f associated with an aircraft, it is understood that the UE 115-f may be any UE 115 (e.g., terrestrial UE 115) that is connect to (e.g., in a coverage area, such as coverage area 110-e) of a network entity 105, such as the network entity 105-d.

As noted above, commercial aircraft-based emergency message relay techniques may extend coverage for an area without one or more terrestrial base stations. A typical cruising altitude of aircraft, such as 10 km, allows for line-of-sight (LoS) propagation for over 200 km. Even though the density of commercial aircraft in any particular location varies region-by-region, overall aircraft coverage is relatively dense during the day. In other words, there may be at least one aircraft visible within 50-100 km in most major remote areas in the U.S.

Multiple aircraft may cover the same out-of-cellular coverage area (also simply referred to as “out-of-coverage area”). As the trajectories of the aircraft may intersect, the on-off control based on the aircraft global navigation satellite system (GNSS) position from the base station may be complicated and/or frequently changed. In UE-initiated discovery, multiple aircraft send feedback messages that may interfere with each other. In aircraft-initiated discovery, the transmission of wake up signals (WUS), synchronization signal blocks (SSBs), and discovery messages may interfere with each other.

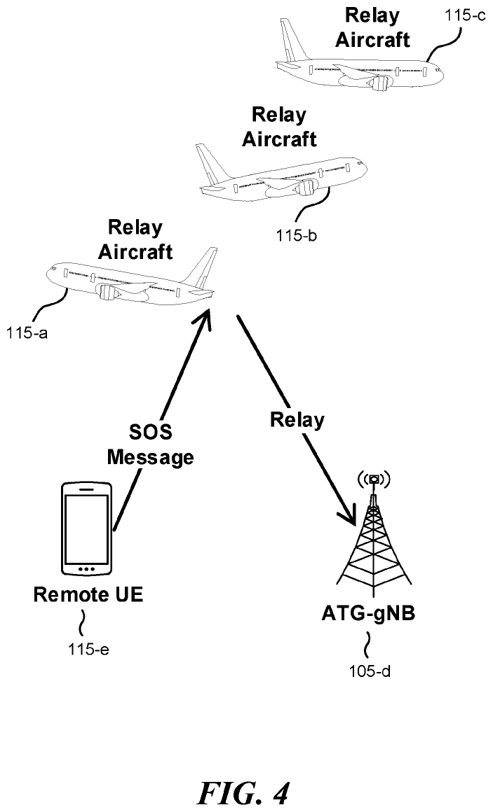

FIG. 4 is a diagram illustrating multiple aircraft covering a same out-of-cellular coverage area, according to aspects of the present disclosure. In the example of FIG. 4, multiple relay aircraft 115-a, 115-b, 115-c all are in range of a remote UE 115-e. The remote UE 115-e may transmit an emergency message (e.g., SOS message) to any or all of the aircraft 115-a, 115-b, 115-c. As a result, any or all of the aircraft 115-a, 115-b, 115-c may relay the message to a network entity 105-d, such as an air-to-ground (ATG) base station (e.g., gNB). Due to the close proximity of each of the aircraft 115-a, 115-b, 115-c to each other, interference may result from the transmissions to and from the aircraft 115-a, 115-b, 115-c. Aspects of the present disclosure aim to reduce the interference. Throughout the disclosure, the aircraft are referred to as UEs for ease of explanation. It is noted, however, that an aircraft may be a UE, a base station, an IAB device, a relay, a smart repeater, or any other such device.

Locating aircraft is an issue. Navigational positioning may include errors. Moreover, flight delays and route changes may prevent accurate forecasting of an aircraft position. During U.S. area navigation type one (RNAV 1) departure procedures (DPs), and standard terminal arrivals (STARs), aircraft must maintain a total system error of not more than 1 NM (1.8 km) for 95 percent of the total flight time. During U.S. area navigation type two (RNAV 2) en-route procedures, aircraft must maintain a total system error of not more than 2 NM (3.6 km) for 95 percent of the total flight time. Thus, signaling for aircraft position reporting is desirable because navigation has km-level errors. Aircraft position reporting may report any deviation between the actual aircraft position and navigation derived position.

Coordination is desired when multiple aircraft participate in relaying. For example, inter-cell coordination and UE coordination may be specified. When multiple aircraft have a common coverage area on the ground, the coordination among aircraft as integrated access and backhaul (IAB) devices or UEs is likely to include inter-cell coordination and UE coordination. Because aircraft are highly mobile, existing techniques may not be sufficient by themselves. Options to improve coordination include enabling one aircraft in the common coverage or scheduling different aircraft to transmit with different resources.

It is assumed that there is little possibility of aircraft switching or beam switching during an emergency message transmission because the message being relayed is very short (e.g., an SOS message). For example, assuming the aircraft speed is 250 m/s and the ground coverage or footprint by one aircraft is a circle of 50 km, then the maximum serving time is 2*50*1000/250=400 seconds.

Aspects of the present disclosure introduce multiplexing and diversity solutions to avoid interference at the remote UE, when multiple relaying aircraft send discovery signals or feedback. For example, multiplexing directs different aircraft to transmit different signals, which improves the possibility of discovery. Diversity directs all aircraft to transmit the same message with different resources, improving the signal-to-noise ratio (SNR) at the remote UE. Both solutions reduce the remote UE search space, thereby saving power at the remote UE. That is, if the remote UE is aware of where to search, the UE does not need to search all possible resources, and can thus save power when searching.

According to aspects of the present disclosure, multiplexing and diversity techniques for multiple aircraft are facilitated by a relay identification (ID). For example, an air-to-ground (ATG) base station (e.g., gNB) or a satellite device assigns aircraft that are in the same out-of-coverage area a dynamic relay ID. The indication may be dynamically indicated via a downlink control information (DCI) message, a media access control-control element (MAC-CE), or may be semi-statically indicated via a MAC-CE or radio resource control (RRC) signaling.

In some aspects, different aircraft transmit to the ground with different resources mapped by the relay ID. The resource selection is transparent to the remote UE. The aircraft may employ multiplexing or diversity techniques with the selected resources. Moreover, the relay ID reduces the search space of the remote UE to a known size. To enable communications between the remote UE and the multiple aircraft, the remote UE and the multiple aircraft synchronize with each other.

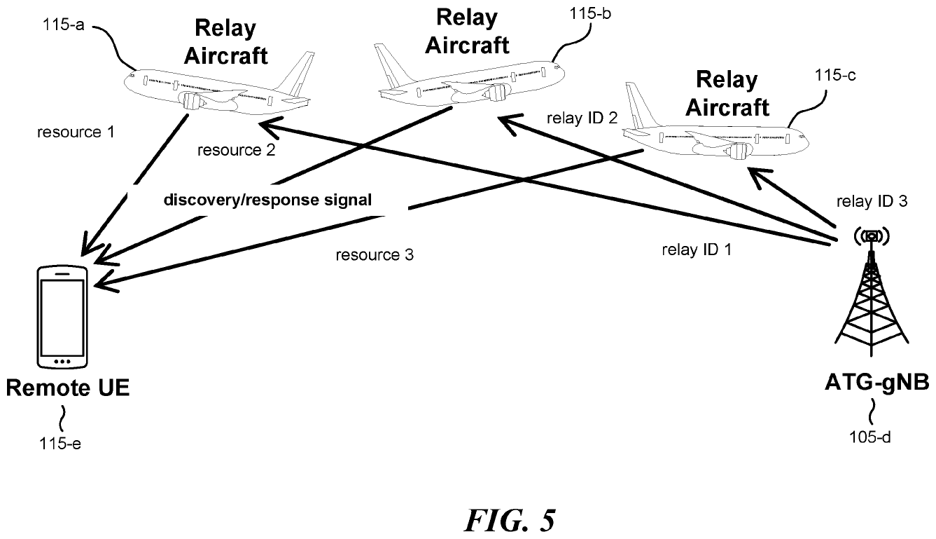

FIG. 5 is a diagram illustrating communications based on relay IDs, in accordance with aspects of the present disclosure. In the example of FIG. 5, the network device 105-d transmits a first relay ID, relay ID 1, to the relay aircraft 115-a. The network device 105-d also transmits a second relay ID, relay ID 2, to the relay aircraft 115-b, and a third relay ID, relay ID 3, to the relay aircraft 115-c. It is noted that the network device 105-d may also be a satellite device, although not shown as such in FIG. 5. Based on the first relay ID, relay ID 1, the relay aircraft 115-a communicates with the remote UE 115-e via resources (resource 1) mapped to the first relay ID, relay ID 1. Based on the second relay ID, relay ID 2, the relay aircraft 115-b communicates with the remote UE 115-e via resources (resource 2) mapped to the second relay ID, relay ID 2. Based on the third relay ID, relay ID 3, the relay aircraft 115-c communicates with the remote UE 115-e via resources (resource 3) mapped to the third relay ID, relay ID 3. The communication may include transmission and/or reception of a discovery signal and/or a response signal. In the example of FIG. 5, the communication includes transmission of a discovery signal and/or a response signal to the remote UE 115-e.

As noted above, the relay ID reduces the remote UE search space. In some implementations, the relay ID format is a bit sequence of length log 2 N. If directing different aircraft to transmit with different resources based on a conventional UE ID, base station ID, or cell ID, the search space of the remote UE would be large. For example, a new radio (NR) cell ID has 36 bits (the first 22˜32 bits are the base station ID, the last 4˜14 bits are the local cell ID). With a smaller relay ID, the search space is smaller.

In aspects of the present disclosure, the network device (e.g., ATG-gNB or satellite) provides each aircraft within the same out-of-coverage area with a dynamic relay ID. The relay ID may be dynamically indicated via downlink control information (DCI) or a MAC-CE, or semi-statically indicated via a MAC-CE or RRC signaling. In some implementations, a maximum number of relay IDs is limited by N. The value of N is known to all aircraft and the remote UE. In an example, an aircraft with the relay ID n transmits with the n-th resource in a resource set of size N. As a result, the remote UE search space is N×(one aircraft resource range+gap).

In some aspects, only a relay aircraft assigned with a relay ID can send signals, such as discovery and feedback signals, to the out-of-coverage area. An aircraft without a relay ID is not permitted to transmit signals in this out-of-coverage area.

Synchronization of multiple aircraft to a remote UE will now be described in more detail. When multiple aircraft synchronize to the remote UE, a timing relationship changes. For example, aircraft may change the timing advance (TA) from the network device to the remote UE. For UE-initiated discovery, where aircraft first receive a message from the remote UE, a first part of a signal sent by the remote UE may be a simplified synchronization signal block (SSB). The aircraft synchronize to the UE based on this signal before sending a response.

For aircraft-initiated discovery, where the remote UE position is unknown to the aircraft, the network device may control the aircraft signaling. For example, the network device may direct each aircraft to transmit a discovery signal towards a same position or zone in the out-of-coverage area. In response, each aircraft calculates its timing advance (TA) for transmissions to the indicated ground position, (e.g., zone), according to its own position. Each aircraft also calculates a frequency compensation value for the indicated ground position (e.g., zone), according to its position and velocity and/or aircraft direction. The frequency compensation accounts for Doppler shift experienced due to the movement of the aircraft.

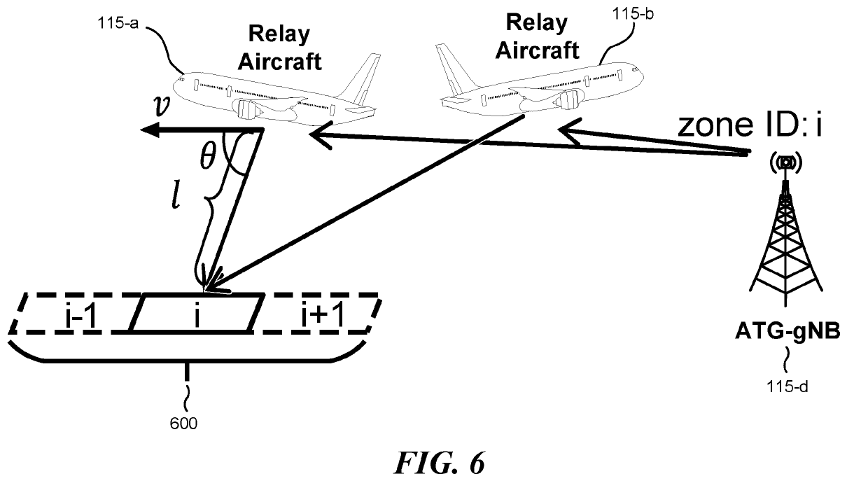

FIG. 6 is a diagram illustrating aircraft synchronization, in accordance with aspects of the present disclosure. In the example of FIG. 6, a network device 105-d transmits zone ID information to the aircraft 115-a, 115-b. The zone ID information indicates zone i. In the example of FIG. 6, three zones 600 are shown: zone i−1, zone i, and zone i+1. Each zone corresponds to an out-of-coverage area where a remote UE is possibly located. Each aircraft 115-a, 115-b calculates a timing advance (TA) based on the formula TA=l/c l, where l is the distance between the aircraft and the zone (zone i in this example) and c represents the speed of light. Each aircraft 115-a, 115-b also calculates a frequency compensation value based on the formula: −ν cos θƒ_{c}/c, where ν is the aircraft velocity, θ is the angle between the velocity direction and the direction toward the zone, ƒ_{c} is the carrier frequency, and c represents the speed of light.

According to aspects of the present disclosure, synchronization of the remote UE to multiple aircraft may be assisted by a relay ID. For example, multiple aircraft may periodically send the same preamble in different resources mapped by assigned relay IDs. In these aspects, it is assumed that all aircraft are synchronized to a network device, a GNSS device, or an inter-aircraft network, such that all aircraft are synchronized together. To facilitate synchronization with the remote UE, the aircraft may add a guard gap between two time or frequency resources to address the high mobility of the aircraft. A time domain guard gap may be obtained by the following exemplary method. For a 10 km distance difference from two aircraft to the remote UE, a propagation delay difference is 33.33 us less than a symbol duration with 15 KHz subcarrier spacing (SCS). Thus, a one symbol duration for a time domain guard gap will be sufficient. A frequency domain guard gap may be obtained by the following exemplary method. For two aircraft traveling in opposite directions with a maximum velocity of 1000 km/h, a Doppler shift difference at the remote UE is 2000/3.6ƒ_{c}/c. For example, when the carrier frequency ƒ_{c}=6 GHz, the Doppler shift difference is 11.1 KHz. Thus, a subcarrier spacing for a frequency domain guard gap will be sufficient.

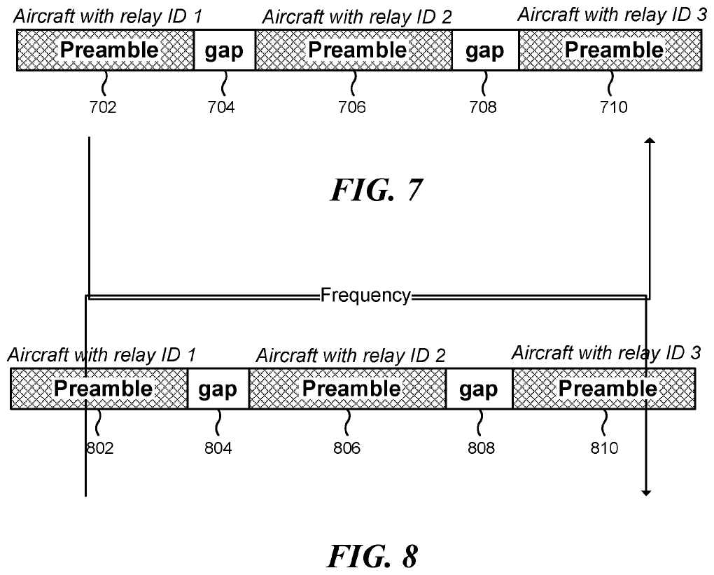

FIG. 7 is a block diagram illustrating time domain guard gaps, according to aspects of the present disclosure. In the example of FIG. 7, a first aircraft with a first relay ID transmits its preamble at time 702. In this example, a one symbol guard gap is present at time 704. After the gap, a second aircraft with a second relay ID transmits its preamble at time 706. Another guard gap is observed at time 708. After the gap at time 708, a third aircraft with a third relay ID transmits its preamble at time 710. By including the time domain guard gap, the preambles from different aircraft are less likely to interfere with one another.

FIG. 8 is a block diagram illustrating frequency domain guard gaps, according to aspects of the present disclosure. In the example of FIG. 8, a first aircraft with a first relay ID transmits its preamble at frequency 802. In this example, a single subcarrier spacing guard gap is present at frequency 804. Spaced from the gap, a second aircraft with a second relay ID transmits its preamble at frequency 806. Another guard gap is observed at frequency 808. Separated by the frequency gap at frequency 808, a third aircraft with a third relay ID transmits its preamble at frequency 810. By including the frequency domain guard gap, the preambles from different aircraft are less likely to interfere with one another.

A size of the remote UE search space for synchronization is based on the gap. For example, a window size may be defined as N×(preamble size+gap size) where N is the total number of relay IDs.

Synchronization of a remote UE to multiple aircraft may also be assisted by the relay ID when multiple aircraft periodically send a same preamble in different resources mapped by assigned relay IDs with code division multiplexing (CDM). When code division multiplexing is employed, time and/or frequency overlap may be permitted. In these aspects, different aircraft may transmit with different orthogonal codes. Code division multiplexing may further reduce the search space of the remote UE. With code division multiplexing, the remote UE may choose one or all aircraft to synchronize with.

In other aspects, the aircraft and the remote UE both synchronize to a satellite. In these aspects, the satellite may send a synchronization signal, such as an SSB, to ground. The aircraft and the remote UE may then synchronize with the satellite's synchronization signal.

The network device may dynamically indicate the relay ID. Dynamic indication may be achieved via downlink control information (DCI) or a MAC-CE. The dynamic indication may be updated based on aircraft position reports. The network device may also semi-statically indicate the relay ID, for example, with a MAC-CE or RRC signaling. The semi-static indication may be based on predicted locations using planned trajectories of the aircraft.

Aspects of the present disclosure introduce a trigger for allocating or recycling a relay ID. The trigger is based on whether an aircraft enters or leaves a zone (e.g., out-of-coverage area). Upon entering the zone, the network device allocates a relay ID to the aircraft. Upon leaving the zone, the network device recycles the relay ID. The network device may determine whether the aircraft enters or leaves a zone based on a position of the aircraft, for example, as reported by the aircraft. Based on the position, the network device can calculate whether the aircraft is entering or leaving a zone. The network device may also determine whether the aircraft is entering or leaving a zone based on a reference signal received power (RSRP) reported by the aircraft for receiving beams from the network device covering the out-of-coverage area. Another way to determine whether the aircraft is leaving a zone may be based on a timer corresponding to the aircraft's route and speed. By knowing when an aircraft enters a zone, the network device can set a timer based on the route and speed of the aircraft, to determine when the aircraft will leave the zone.

A maximum number of relay ID may be limited to N relay IDs, with the value of N being known to the aircraft and remote UE. When all of the N relay IDs have been assigned to the out-of-coverage area, in some aspects, no additional aircraft will be assigned relay IDs. When an aircraft leaves the out-of-coverage area, its relay ID may be recycled.

Resource allocation for aircraft-to-UE transmission based on a relay ID is now discussed. A network device, such as an ATG-gNB or satellite, may indicate a domain of the aircraft multiplexing or diversity, for example, time, frequency, or code domain. The network device may also indicate to the aircraft a time and/or frequency resource range, a gap, and an overall starting time and/or starting frequency. If there are time and/or frequency overlaps for multiple aircraft, the network device may indicate to the aircraft a code division multiplexing (CDM) code index.

Based on the information received from the network device, each aircraft transmits using the resource mapped by its relay ID. In an example implementation of synchronization, each aircraft calculates the start and stop position of the resource as follows:

$$\begin{matrix}Start : overall\_start + ( range + gap ) * ( relay\_ID - 1 ) \\ Stop : start + range\end{matrix}$$

A remote UE should know in advance whether the aircraft uses time division multiplexing (TDM), frequency division multiplexing (FDM), or code division multiplexing (CDM), the time/frequency/code resource range and a gap used by the aircraft, and the total number of relay IDs.

Aspects of the present disclosure avoid interference to the remote UE from multiple aircraft. Aspects also reduce the remote UE search space, saving UE power. Moreover, SNR is improved for the remote UE, as is the discovery possibility.

As indicated above, FIGS. 2-8 are provided as examples. Other examples may differ from what is described with respect to FIGS. 2-8.

FIG. 9 is a flow diagram illustrating an example process 900 performed, for example, by an aircraft-based device, in accordance with various aspects of the present disclosure. The example process 900 is an example of resource multiplexing and transmit diversity for multi-aircraft emergency message relaying. The operations of the process 900 may be implemented by a user equipment (UE) 115, a base station, an IAB device, a relay, a smart repeater, or any other such device.

As shown in FIG. 9, in some aspects, the process 900 may include receiving a dynamic relay identification ID (block 902). The process may also include synchronizing to a satellite synchronization signal. The process may further include receiving a resource range, a starting resource to enable calculating of resources for communicating the discovery signal, and a code and/or a gap duration.

In some aspects, the process 900 may include communicating a discovery signal with resources mapped to the relay ID (block 904). For example, the device may communicating the discovery signal by receiving the discovery signal from the remote UE, such that the device synchronizes with the remote UE based on the discovery signal prior to transmitting the response signal. In other examples, the device may communicate the discovery signal by transmitting the discovery signal towards a zone of an out-of-coverage area, such that the device calculates a timing advance based on a position of the aircraft-based device and the zone, and calculates a frequency compensation based on at least one of: a velocity and a direction of the aircraft-based device; and the position of the aircraft-based device. The discovery signal may include a first preamble that is the same as another aircraft-based device's preamble. The device may transmit a subsequent preamble offset by a time domain guard gap and/or a frequency domain guard gap. In some implementations, the device may transmit a subsequent preamble overlapping with the first preamble, the first preamble and the subsequent preamble having different orthogonal cover codes.

In some aspects, the process 900 may include communicating a response signal with resources mapped to the relay ID (block 906). The device may also synchronize with a remote user equipment (UE), outside of terrestrial cellular coverage, based on the discovery signal and the response signal; and relay an emergency message from the remote UE to a network device, after synchronizing with the remote UE.

FIG. 10 is a flow diagram illustrating an example process 1000 performed, for example, by a network device, in accordance with various aspects of the present disclosure. The example process 1000 is an example of resource multiplexing and transmit diversity for multi-aircraft emergency message relaying. The operations of the process 900 may be implemented by a network device 105-d.

As shown in FIG. 10, in some aspects, the process 1000 may include estimating a position of each of a number of aircraft-based devices (block 1002). The device may estimate the position of each of the aircraft-based devices based on a predicted trajectory of each of the plurality of aircraft-based devices. In other aspects, the device may estimate the position of each of the aircraft-based devices based on reported information from each of the plurality of aircraft-based devices. The reported information may comprise at least one of: a position of an aircraft-based device, a reference signal receive power (RSRP) for beams received from the network device, and timer information.

In some aspects, the process 1000 may include transmitting a dynamic relay identification (ID) to each of the number of aircraft-based devices based on the respective estimated position relative to an out-of-coverage area. (block 1004). The device may receive an emergency message from a remote user equipment (UE) relayed via at least one of the aircraft-based devices. The device may also transmit both a resource range and a starting resource to enable calculating resources by each of the plurality of aircraft-based devices for communicating a discovery signal, and a code and/or a gap duration. In some implementations, the device may stop assigning dynamic relay IDs to additional aircraft-based devices in response to a threshold number of dynamic relays IDs having been assigned. The device may re-assign a dynamic relay ID from a first aircraft-based device that has left the out-of-coverage area to a second aircraft-based device in the out-of-coverage area.

### Example Aspects

Aspect 1: A method of wireless communication by an aircraft-based device, comprising: receiving a dynamic relay identification (ID); communicating a discovery signal with resources mapped to the relay ID; and communicating a response signal with the resources mapped to the relay ID.

Aspect 2: The method of Aspect 1, further comprising: synchronizing with a remote user equipment (UE), outside of terrestrial cellular coverage, based on the discovery signal and the response signal; and relaying an emergency message from the remote UE to a network device, after synchronizing with the remote UE.

Aspect 3: The method of Aspect 1 or 2, in which communicating the discovery signal comprises receiving the discovery signal from the remote UE, the method further comprising synchronizing with the remote UE based on the discovery signal prior to transmitting the response signal.

Aspect 4: The method of Aspect 1 or 2, in which communicating the discovery signal comprises transmitting the discovery signal towards a zone of an out-of-coverage area, the method further comprising calculating a timing advance based on a position of the aircraft-based device and the zone, and calculating a frequency compensation based on at least one of: a velocity and a direction of the aircraft-based device; and the position of the aircraft-based device.

Aspect 5: The method of any of the preceding Aspects, in which the discovery signal includes a first preamble that is the same as another aircraft-based device's preamble.

Aspect 6: The method of any of the preceding Aspects, further comprising transmitting a subsequent preamble offset by a time domain guard gap and/or a frequency domain guard gap.

Aspect 7: The method of any of the preceding Aspects, further comprising transmitting a subsequent preamble overlapping with the first preamble, the first preamble and the subsequent preamble having different orthogonal cover codes.

Aspect 8: The method of any of the preceding Aspects, further comprising synchronizing to a satellite synchronization signal.

Aspect 9: The method of any of the preceding Aspects, further comprising receiving a resource range, a starting resource to enable calculating of resources for communicating the discovery signal, and a code and/or a gap duration.

Aspect 10: A method of wireless communication by a network device, comprising: estimating a position of each of a plurality of aircraft-based devices; and transmitting a dynamic relay identification (ID) to each of the plurality of aircraft-based devices based on the respective estimated position relative to an out-of-coverage area.

Aspect 11: The method of Aspect 10, further comprising receiving an emergency message from a remote user equipment (UE) relayed via at least one of the plurality of aircraft-based devices.

Aspect 12: The method of Aspect 10 or 11, further comprising transmitting both a resource range and a starting resource to enable calculating resources by each of the plurality of aircraft-based devices for communicating a discovery signal, and a code and/or a gap duration.

Aspect 13: The method of any of the Aspects 10-12, in which estimating the position of each of the plurality of aircraft-based devices is based on a predicted trajectory of each of the plurality of aircraft-based devices.

Aspect 14: The method of any of the Aspects 10-13, in which estimating the position of each of the plurality of aircraft-based devices is based on reported information from each of the plurality of aircraft-based devices.

Aspect 15: The method of any of the Aspects 10-14, in which the reported information comprises at least one of: a position of an aircraft-based device, a reference signal receive power (RSRP) for beams received from the network device, and timer information.

Aspect 16: The method of any of the Aspects 10-15, further comprising stopping assigning dynamic relay IDs to additional aircraft-based devices in response to a threshold number of dynamic relays IDs having been assigned.

Aspect 17: The method of any of the Aspects 10-16, further comprising re-assigning a dynamic relay ID from a first aircraft-based device that has left the out-of-coverage area to a second aircraft-based device in the out-of-coverage area.

Aspect 18: An apparatus for wireless communication, comprising: a memory; and at least one processor coupled to the memory, the at least one processor configured: to receive a dynamic relay identification (ID); to communicate a discovery signal with resources mapped to the relay ID; and to communicate a response signal with the resources mapped to the relay ID.

Aspect 19: The apparatus of Aspect 18, in which the at least one processor is further configured: to synchronize with a remote user equipment (UE), outside of terrestrial cellular coverage, based on the discovery signal and the response signal; and to relay an emergency message from the remote UE to a network device, after synchronizing with the remote UE.

Aspect 20: The apparatus of Aspect 18 or 19, in which the at least one processor communicates the discovery signal by receiving the discovery signal from the remote UE, and is further configured to synchronize with the remote UE based on the discovery signal prior to transmitting the response signal.

Aspect 21: The apparatus of Aspect 18 or 19, in which the at least one processor communicates the discovery signal by transmitting the discovery signal towards a zone of an out-of-coverage area, and is further configured to calculate a timing advance based on a position of the aircraft-based device and the zone, and calculate a frequency compensation based on at least one of: a velocity and a direction of the aircraft-based device; and the position of the aircraft-based device.

Aspect 22: The apparatus of any of the Aspects 18-21, in which the discovery signal includes a first preamble that is the same as another aircraft-based device's preamble.

Aspect 23: The apparatus of any of the Aspects 18-22, in which the at least one processor is further configured to transmit a subsequent preamble offset by a time domain guard gap and/or a frequency domain guard gap.

Aspect 24: The apparatus of any of the Aspects 18-23, in which the at least one processor is further configured to transmit a subsequent preamble overlapping with the first preamble, the first preamble and the subsequent preamble having different orthogonal cover codes.

Aspect 25: The apparatus of any of the Aspects 18-24, in which the at least one processor is further configured to synchronize to a satellite synchronization signal.

Aspect 26: The apparatus of any of the Aspects 18-25, in which the at least one processor is further configured to receive a resource range, a starting resource to enable calculating of resources for communicating the discovery signal, and a code and/or a gap duration.

Aspect 27: An apparatus for wireless communication by a network device, comprising: a memory; and at least one processor coupled to the memory, the at least one processor configured: to estimate a position of each of a plurality of aircraft-based devices; and to transmit a dynamic relay identification (ID) to each of the plurality of aircraft-based devices based on the respective estimated position relative to an out-of-coverage area.

Aspect 28: The apparatus of Aspect 27, in which the at least one processor is further configured to receive an emergency message from a remote user equipment (UE) relayed via at least one of the plurality of aircraft-based devices.

Aspect 29: The apparatus of Aspect 27 or 28, in which the at least one processor is further configured to transmit both a resource range and a starting resource to enable calculating resources by each of the plurality of aircraft-based devices for communicating a discovery signal, and a code and/or a gap duration.

Aspect 30: The apparatus of any of the Aspects 27-29, in which the at least one processor estimates the position of each of the plurality of aircraft-based devices based on a predicted trajectory of each of the plurality of aircraft-based devices.

The foregoing disclosure provides illustration and description, but is not intended to be exhaustive or to limit the aspects to the precise form disclosed. Modifications and variations may be made in light of the above disclosure or may be acquired from practice of the aspects.

As used, the term “component” is intended to be broadly construed as hardware, firmware, and/or a combination of hardware and software. As used, a processor is implemented in hardware, firmware, and/or a combination of hardware and software.

Some aspects are described in connection with thresholds. As used, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described may be implemented in different forms of hardware, firmware, and/or a combination of hardware and software. The actual specialized control hardware or software code used to implement these systems and/or methods is not limiting of the aspects. Thus, the operation and behavior of the systems and/or methods were described without reference to specific software code—it being understood that software and hardware can be designed to implement the systems and/or methods based, at least in part, on the description.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used should be construed as critical or essential unless explicitly described as such. Also, as used, the articles “a” and “an” are intended to include one or more items, and may be used interchangeably with “one or more.” Furthermore, as used, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used, the terms “has,” “have,” “having,” and/or the like are intended to be open-ended terms. Further, the phrase “based on” is intended to mean “based, at least in part, on” unless explicitly stated otherwise.

What is claimed is:

1. A method of wireless communication by an aircraft-based device, comprising:
receiving a dynamic relay identification (ID);
communicating a discovery signal with resources mapped to the relay ID; and
communicating a response signal with the resources mapped to the relay ID.

2. The method of claim 1, further comprising:
synchronizing with a remote user equipment (UE), outside of terrestrial cellular coverage, based on the discovery signal and the response signal; and
relaying an emergency message from the remote UE to a network device, after synchronizing with the remote UE.

3. The method of claim 2, in which communicating the discovery signal comprises receiving the discovery signal from the remote UE, the method further comprising synchronizing with the remote UE based on the discovery signal prior to transmitting the response signal.

4. The method of claim 1, in which communicating the discovery signal comprises transmitting the discovery signal towards a zone of an out-of-coverage area, the method further comprising calculating a timing advance based on a position of the aircraft-based device and the zone, and calculating a frequency compensation based on at least one of: a velocity and a direction of the aircraft-based device; and the position of the aircraft-based device.

5. The method of claim 1, in which the discovery signal includes a first preamble that is the same as another aircraft-based device's preamble.

6. The method of claim 5, further comprising transmitting a subsequent preamble offset by a time domain guard gap and/or a frequency domain guard gap.

7. The method of claim 5, further comprising transmitting a subsequent preamble overlapping with the first preamble, the first preamble and the subsequent preamble having different orthogonal cover codes.

8. The method of claim 1, further comprising synchronizing to a satellite synchronization signal.

9. The method of claim 1, further comprising receiving a resource range, a starting resource to enable calculating of resources for communicating the discovery signal, and a code and/or a gap duration.

10. A method of wireless communication by a network device, comprising:
estimating a position of each of a plurality of aircraft-based devices; and
transmitting a dynamic relay identification (ID) to each of the plurality of aircraft-based devices based on the respective estimated position relative to an out-of-coverage area.

11. The method of claim 10, further comprising receiving an emergency message from a remote user equipment (UE) relayed via at least one of the plurality of aircraft-based devices.

12. The method of claim 10, further comprising transmitting both a resource range and a starting resource to enable calculating resources by each of the plurality of aircraft-based devices for communicating a discovery signal, and a code and/or a gap duration.

13. The method of claim 10, in which estimating the position of each of the plurality of aircraft-based devices is based on a predicted trajectory of each of the plurality of aircraft-based devices.

14. The method of claim 10, in which estimating the position of each of the plurality of aircraft-based devices is based on reported information from each of the plurality of aircraft-based devices.

15. The method of claim 14, in which the reported information comprises at least one of: a position of an aircraft-based device, a reference signal receive power (RSRP) for beams received from the network device, and timer information.

16. The method of claim 10, further comprising stopping assigning dynamic relay IDs to additional aircraft-based devices in response to a threshold number of dynamic relays IDs having been assigned.

17. The method of claim 10, further comprising re-assigning a dynamic relay ID from a first aircraft-based device that has left the out-of-coverage area to a second aircraft-based device in the out-of-coverage area.

18. An apparatus for wireless communication by an aircraft-based device, comprising:
a memory; and
at least one processor coupled to the memory, the at least one processor configured:
to receive a dynamic relay identification (ID);
to communicate a discovery signal with resources mapped to the relay ID; and
to communicate a response signal with the resources mapped to the relay ID.

19. The apparatus of claim 18, in which the at least one processor is further configured:
to synchronize with a remote user equipment (UE), outside of terrestrial cellular coverage, based on the discovery signal and the response signal; and
to relay an emergency message from the remote UE to a network device, after synchronizing with the remote UE.

20. The apparatus of claim 19, in which the at least one processor communicates the discovery signal by receiving the discovery signal from the remote UE, and is further configured to synchronize with the remote UE based on the discovery signal prior to transmitting the response signal.

21. The apparatus of claim 18, in which the at least one processor communicates the discovery signal by transmitting the discovery signal towards a zone of an out-of-coverage area, and is further configured to calculate a timing advance based on a position of the aircraft-based device and the zone, and calculate a frequency compensation based on at least one of: a velocity and a direction of the aircraft-based device; and the position of the aircraft-based device.

22. The apparatus of claim 18, in which the discovery signal includes a first preamble that is the same as another aircraft-based device's preamble.

23. The apparatus of claim 22, in which the at least one processor is further configured to transmit a subsequent preamble offset by a time domain guard gap and/or a frequency domain guard gap.

24. The apparatus of claim 22, in which the at least one processor is further configured to transmit a subsequent preamble overlapping with the first preamble, the first preamble and the subsequent preamble having different orthogonal cover codes.

25. The apparatus of claim 18, in which the at least one processor is further configured to synchronize to a satellite synchronization signal.

26. The apparatus of claim 18, in which the at least one processor is further configured to receive a resource range, a starting resource to enable calculating of resources for communicating the discovery signal, and a code and/or a gap duration.

27. An apparatus for wireless communication by a network device, comprising:
a memory; and
at least one processor coupled to the memory, the at least one processor configured:
to estimate a position of each of a plurality of aircraft-based devices; and
to transmit a dynamic relay identification (ID) to each of the plurality of aircraft-based devices based on the respective estimated position relative to an out-of-coverage area.

28. The apparatus of claim 27, in which the at least one processor is further configured to receive an emergency message from a remote user equipment (UE) relayed via at least one of the plurality of aircraft-based devices.

29. The apparatus of claim 27, in which the at least one processor is further configured to transmit both a resource range and a starting resource to enable calculating resources by each of the plurality of aircraft-based devices for communicating a discovery signal, and a code and/or a gap duration.

30. The apparatus of claim 27, in which the at least one processor is configured to estimate the position of each of the plurality of aircraft-based devices based on a predicted trajectory of each of the plurality of aircraft-based devices.
